(19) United States
(12) Patent Application Publication
(10) Pub. No.: US 2025/0223947 A1
(43) Pub. Date: Jul. 10, 2025

(54) METHOD AND DEVICE FOR DETERMINING UPDATED STATISTICAL LIFE OF A BEARING, AND WIND TURBINE INCLUDING THE DEVICE

(71) Applicant: AKTIEBOLAGET SKF, GOTEBORG (SE)

(72) Inventors: Stefan ENGBERS, Neuenkirchen (DE); Dominik FRITZ, Würzburg (DE); Andreas Clemens VAN DER HAM, Warnsveld (NL); Stephan BAGGEROHR, Houten (NL); Defeng LANG, Delft (NL)

(21) Appl. No.: 18/999,154

(22) Filed: Dec. 23, 2024

(30) Foreign Application Priority Data
Jan. 9, 2024 (DE) 102024200162.7

(51) Int. Cl. F03D 17/00

(52) U.S. Cl. CPC F03D 17/032; F05D 2240/50; F05D 2260/15; F05D 2260/80; F05D 2270/80

(57) ABSTRACT

A method and for determining an updated statistical life value of a rolling bearing in a machine, the rolling bearing including a stationary ring and a rotatable ring and at least one row of rolling elements interposed between raceways of the ring, at least one of the rolling elements being a sensorized rolling element having a load sensor configured to measure a load distribution across the sensorized rolling element. The method includes determining a set of measurements, each measurement including at least load values of the load distribution measured by the load sensor of the sensorized rolling element, for each measurement, determining a life rating value from at least the load values of the measurement and from a rating life model of the bearing, and determining the updated statistical life value from at least the life rating values.

### CROSS-REFERENCE

This application claims priority to German patent application no. 10 2024 200 162.7 filed on Jan. 9, 2024, the contents of which are fully incorporated herein by reference.

### TECHNOLOGICAL FIELD

The present disclosure is directed to a method and device for determining a life rating of bearings, and more particularly to a method and device for determining an updated statistical life of a bearing in a machine and to a wind turbine including the device.

### BACKGROUND

During the design phase of a bearing, a rating life of the bearing is generally calculated based on assumed or estimated application conditions and load cycles representative of the relevant operating conditions of the bearing using a suitable simulation model of the bearing and surrounding components.

It is known to perform simulation of the bearing, accelerated life testing of the bearing and field testing to validate assumptions made during the design phase. However, actual operating conditions of the bearing are not taken into account during this process. For example, the bearing may be installed in a wind turbine, and loads that vary due to wind speed fluctuations and turbulence experienced by the bearing are not taken into account.

Because bearing life calculations based on measurement data are not available, condition monitoring systems and bearing inspections must be used to analyze the bearing status. Condition monitoring systems may be used and bearing inspections may performed when the bearing is damaged to investigate defects on the bearing, for example damage caused by particles in the bearing, worn raceway surfaces, etc.

### SUMMARY

Consequently, an aspect of the present disclosure is to take into account the conditions of use of the bearing in a machine to determine a life rating of the bearing, and a method for determining an updated statistical life value of a rolling bearing in a machine is disclosed.

The rolling bearing comprises a stationary ring and a rotatable ring configured to rotate concentrically relative to one another and at least one row of rolling elements interposed between a first raceway and a second raceway respectively provided on the first and second rings.

At least one of the rolling elements is a sensorized rolling element comprising at least a load sensor configured to measure a load distribution across the sensorized rolling element.

The method includes determining a set of measurements, each measurement comprising at least load values of the load distribution measured by the load sensor of the sensorized rolling element, and for each measurement, determining a life rating value from at least the load values of the measurement and from a rating life model of the bearing, and determining an updated statistical life value of the bearing from at least the life rating values.

The updated statistical life (USL) is an indicator that allows a comparison of application conditions during operation to initially assumed or estimated application conditions and thus to identify critical application conditions, which might lead to damages or accelerated damage accumulation, in order to increase the operating time of the bearing and reduce unplanned downtime of the machine in which the bearing is installed.

The USL with the method for determining the USL may be determined continuously as measurements are performed continuously. The USL allows a determination of a trend of the bearing life. If the USL is deviating from expected values, counteractions and/or adjustments on the application might be initiated to prolong the bearing life.

Preferably, the sensorized rolling element further comprises a temperature sensor for measuring a temperature of the sensorized rolling element and a speed sensor for measuring a rotational speed of the sensorized rolling element, each measurement further comprising a temperature value and a rotational speed value. The life rating value of each measurement is determined further from the temperature value of the measurement, the rotational speed value of the measurement, geometrical features of the bearing and features of a lubricant of the bearing and the rating life model.

Advantageously, the method further comprises determining a misalignment value between the raceway of the stationary ring and the raceway of the rotatable ring from the load distribution, the life rating value of each measurement being determined further from the misalignment value.

Preferably, the method further comprises determining a machine value of at least one parameter representative of the conditions of use of the machine associated with each measurement, and for each measurement, storing the life rating value and the associated machine value.

Advantageously, the method further comprises determining an actual machine value of the parameter representative of the conditions of use of the machine, and comparing the actual machine value and the stored machine values to find a stored machine value equal to the actual machine value. The updated statistical life value is determined from the life rating values and the stored life rating value associated with the stored machine value equal to the actual machine value. Preferably, the machine is a wind turbine.

According to another aspect, a device for determining updated statistical life value of a rolling bearing in a machine is provided.

The rolling bearing comprises a stationary ring and a rotatable ring configured to rotate concentrically relative to one another and at least one row of rolling elements interposed between a first raceway and a second raceway respectively provided on the first and second rings.

The device further includes a sensorized rolling element replacing a rolling element of the row of rolling elements, and the sensorized rolling element comprises at least a load sensor configured to measuring a load distribution across the sensorized rolling, the load distribution comprising load values. The device also includes a rating life model of the bearing, first determining means configured to determine, for each measurement, a life rating value from at least the load values of the load distribution of the measurement and from the rating life model of the bearing, and second determining means configured to determine the updated statistical life value from at least the life rating values.

Preferably, the device further includes third determining means configured to determine a machine value of at least one parameter representative of the conditions of use of the machine associated with each measurement, and storing means configured to store, for each measurement, the life rating value and the associated machine value.

Advantageously, the third determining means are further configured to determine an actual machine value of the parameter representative of the conditions of use of the machine, and the device further includes comparing means configured to compare the actual machine value and the stored machine values to find a stored machine value equal to the actual machine value, and the second determining means are further configured to determine the updated statistical life value from the life rating values and the stored life rating value associated with the stored machine value equal to the actual machine value.

According to another aspect, a wind turbine comprising a rolling bearing is provided.

The rolling bearing comprises a stationary ring and a rotatable ring configured to rotate concentrically relative to one another and at least one row of rolling elements interposed between a first raceway and a second raceway respectively provided on the first and second rings, and a device as defined above.

### BRIEF DESCRIPTION OF THE DRAWINGS

Other advantages and features of the disclosure will appear on examination of the detailed description of embodiments, in no way restrictive, and the appended drawings in which:

FIG. 1 is a schematic depiction of a machine according to an embodiment of the disclosure.

FIG. 2 is a sectional view of a portion of a roller bearing according to an embodiment of the present disclosure.

FIG. 3 is a perspective view of a sensorized rolling element according to an embodiment of the disclosure.

FIG. 4 is a schematic illustration of a processing module according to an embodiment of the disclosure.

FIG. 5 is a flow chart showing a method for determining updated statistical life of a bearing in a machine according to an embodiment of the disclosure.

### DETAILED DESCRIPTION

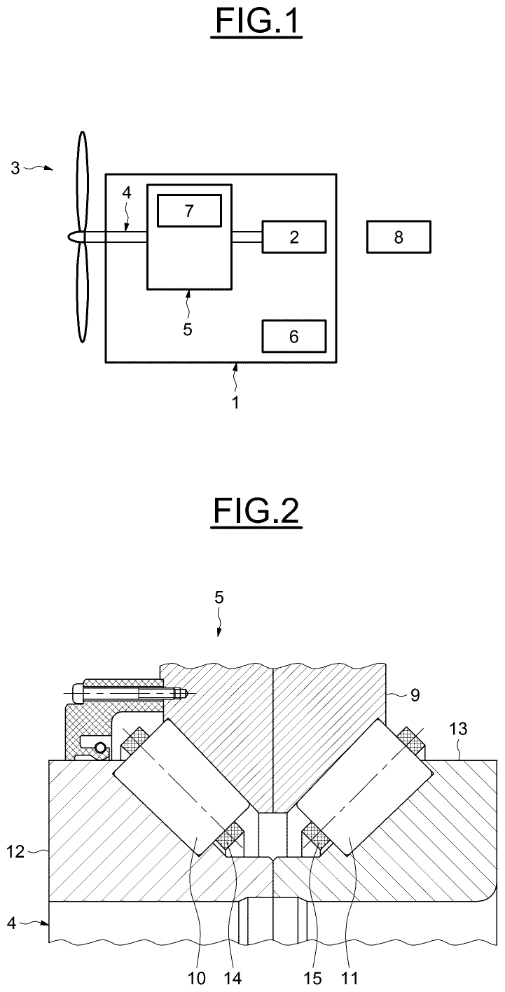

Reference is made to FIG. 1 which represents schematically an example of a machine 1. The machine 1 may be a wind turbine comprising a generator 2, a propeller 3, a shaft 4 connecting a shaft of the generator 2 to the propeller 3, and a roller bearing 5 supporting the shaft 4. In other embodiments, the machine 1 may be a tunnel boring machine, a mining extraction machine or a large offshore crane.

The machine 1 may further comprise a sensor 6 to measure values of a parameter representative of a condition of use of the machine 1. The parameter representative of the condition of use of the machine may be for example the wind speed or the power generated by the wind turbine 1. The roller bearing 5 also includes at least one sensorized rolling element 7.

In a non-represented variant, the wind turbine further comprises a gearbox connecting the shaft of the generator 2 to the shaft 4 of the wind turbine, and the sensorized rolling element 7 may be present in a bearing in the gearbox.

The sensor 6 and the sensorized rolling element 7 communicate with a processing module 8 via a wired connection or a wireless connection. The sensorized rolling element 7 communicates wirelessly with the processing module 8. An example of the processing module 8 is described below.

FIG. 2 schematically illustrates an example of the roller bearing 5 which includes an outer ring or stationary ring 9 provided with conically shaped first and second outer raceways for a first row 10 and a second row 11 of rolling elements comprising tapered rollers. The bearing further comprises a rotatable inner ring formed by a first inner ring 12 and a second inner ring 13 axially adjacent to one another and which are respectively provided with conically shaped first and second inner raceways for the first and second roller rows 10, 11. In addition, the bearing 5 further comprises a first cage 14 and a second cage 15 for retaining the rollers of the first and second roller sets respectively. Typically, the cages may be formed from segments that abut each other in circumferential direction.

To provide the necessary stiffness and ensure a long service life, the bearing is preloaded. The axial positions of the first and second rotatable rings 12, 13 relative to the stationary ring 9 is set such that the first and second rows of rollers 10, 11 have a negative internal clearance (in other words, a preload). In variant, the bearing may not be preloaded.

In the depicted bearing, at least one of the rolling elements in either the first or second row of rollers 10, 11 is replaced with the sensorized rolling element 7. The shaft 4 is surrounded and fixed to the rotatable rings 12, 13.

The rolling bearing 5 of FIG. 2 comprises tapered rollers. In another embodiment, the rolling bearing 5 may comprise other type of rolling elements, for example cylindrical rollers or spherical rollers. The rolling bearing 5 may also comprise only one row of rolling elements or more than two rows of rolling elements, the number of cage being determined according to the number of row.

The rolling bearing 5 comprising a row of rolling elements comprises a unique inner ring.

In another embodiment, the outer ring 9 is the rotatable ring and the inner rings 12, 13 are the stationary rings.

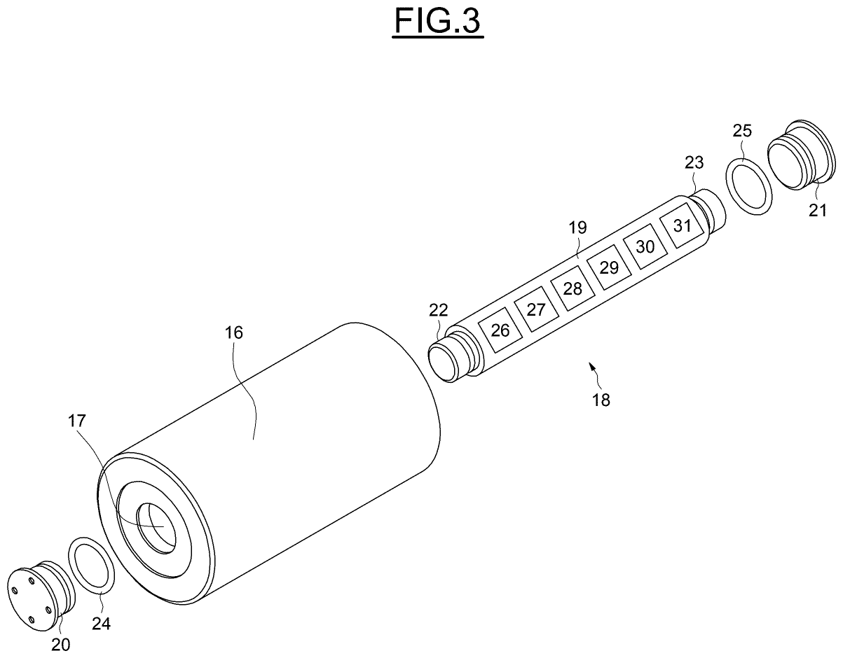

FIG. 3 illustrates schematically an example of the sensorized rolling element 7. The sensorized rolling element 7 comprises a roller body 16 having a central bore 17 and a sensor unit 18 in the central bore 17 that extends through the roller body 16.

The sensor unit 18 comprises a housing 19 formed from two semi-cylindrical housings which are fixed together by first and second end caps 20, 21 that screw onto corresponding first and second threaded portions 22, 23 at opposite axial ends of the housing. The sensor unit housing as a whole is shaped to fit within the central bore 17 and is mounted to and located in the central bore 17 by first and second sealing elements 24, 25.

The sensor unit 18 further includes a load sensor 26 for measuring the load distribution across the sensorized rolling element 7. The load distribution comprises load values. The sensor unit 18 may further include a speed sensor 27 for measuring a rotational speed of the sensorized rolling element 7 in the bearing 5 and may further include a temperature sensor 28 for measuring the temperature of the sensorized rolling element 7.

The sensor unit 18 also includes a wireless transmitter 29 to transmit sets of measurements of the sensors 26, 27, 28, a sampler 30 to sample signals delivered by the sensors and a battery 31 for powering the sensors 26, 27, 28 and the wireless transmitter.

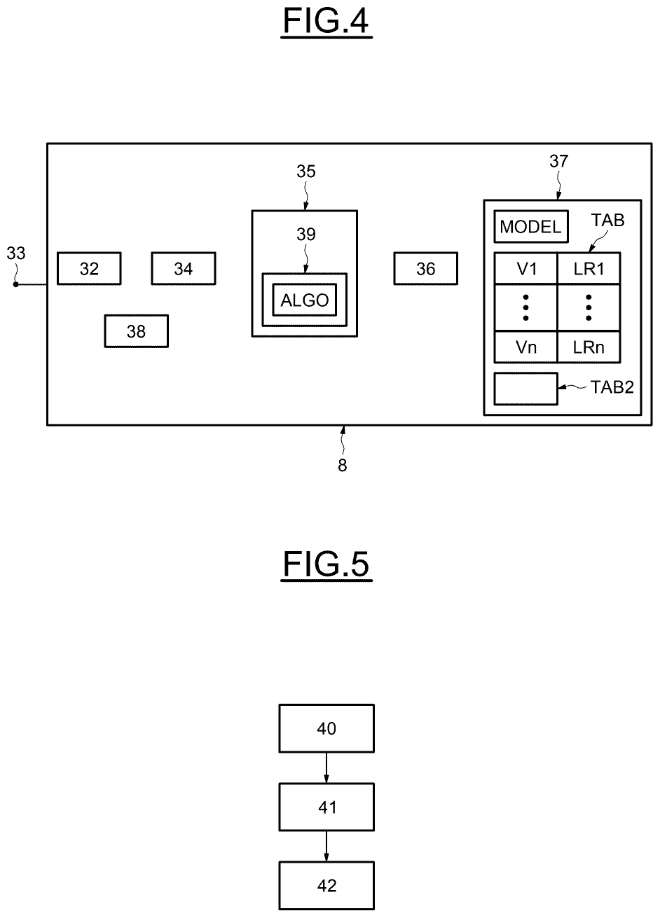

FIG. 4 illustrates schematically an example of the processing module 8. The processing module 8 includes a receiving circuit 32 connected to an antenna 33 of the processing module 8, first determining means 34, second determining means 35, third determining means 36, storage means 37 and comparing means 38. The first, second and third determining means may comprise one or more programmable hardware components, wherein a programmable hardware component can be formed by a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

The receiving circuit 32 receives through the antenna 33 a real time signal emitted by the wireless transmitter of the sensor unit 18 and which signal carries sets of measurements of the sensors 26, 27, 28.

The storage means 37 store a rating life model (MODEL) of the bearing 5, may store a table TAB and may further store a look-up table TAB2. The first determining means 34 is intended to receive the temporal continuous signal comprising a set of measurements of the sensors 26, 27, 28 and is intended to determine life rating value for each measurement of the set of measurements from at least the load values of the measurement and from the rating life model (MODEL). The first determining means may comprise a circuit having circuit elements.

The second determining means 35 are intended to determine the updated statistical life USL value from the life rating values delivered by the first determining means 34. The second determining means may comprise a circuit having circuit elements. The second determining means 35 may also include a computation means 39 implementing a Palmgren-Miner rule algorithm (ALGO).

A rating life model is a deterministic model that determines, based on input of application data, a number of revolutions done by one of two rings rotating concentrically of the bearing or washers of the bearing in relation to the other ring or washer before the first evidence of fatigue develops in the material of one of the two rings or in the material of one of the washers or in the material of one of the rolling elements.

The rating life model (MODEL) may comprise the basic rating life model defined in ISO 281, comprising a relationship between a load value P and a basic life rating value L10ᵢ of a measurement i, the relationship being equal to:

$$L {10}_{i} = {( \frac{C}{P} )}^{p}$$

where:
L10ᵢ: the basic rating life value at 90% probability in millions of revolutions,
C: the dynamic load rating in kN,
P: the equivalent dynamic bearing load in kN determined from the load distribution measured by the load sensor 26, and
p: a geometrical constant (3 for ball bearings, 10/3 for roller bearings).

In variant, the rating life model (MODEL) may take into account more than the load. The rating life model (MODEL) may for example take into account features of a lubricant of the bearing 5 comprising lubrification condition of the bearing 5 and contamination of the bearing 5, and geometrical features of the bearing 5.

The rating life model (MODEL) may comprise the modified rating life model defined in ISO 281, comprising a relationship between the modified rating life value Lₙₘ, the basic life rating value L10ᵢ, a life modification factor a₁ for reliability and a life modification factor also, is equal to:

$${L}_{nm} = {a}_{1} {a}_{ISO} L {10}_{i}$$

where Lₐₘ is the modified rating life value at n probability in millions of revolutions and a₁ is the life modification factor for reliability.

The life modification factor arso is equal to:

$${a}_{ISO} = f ( \frac{{e}_{C} {C}_{u}}{P} , 𝒦 , )$$

where the factors e_{c} and K take into account consideration features of a lubricant of the bearing 5 including contamination and lubricating condition of the bearing 5, and Cᵤ is a fatigue load limit defined as the load at which fatigue stress limit is just reached in the most heavily loaded raceway contact.

The factor κ is equal to the kinematic viscosity of the lubricant of the bearing 5 divided by a reference kinematic viscosity of the lubricant. The factor κ is determined from the rotational bearing speed nᵢ, geometrical features of the bearing 5 comprising the pitch diameter of the bearing 5 and the temperature of the bearing 5. The temperature of the bearing 5 is delivered by the temperature sensor 28.

The rotational bearing speed nᵢ, equal to the rotational speed of the shaft 4, is determined from the rotational speed of the sensorized rolling element 7 measured by the speed sensor 27 of the sensorized rolling element 7 and geometrical features of the bearing 5 according to the following equation:

$${n}_{R} = \frac{1}{2} \frac{{d}_{m}}{D} {n}_{i} [ 1 - {( \frac{D}{{d}_{m}} cos α )}^{2} ]$$

where:
n_{R}: rotational speed of the sensorized rolling element 7,
dₘ: pitch diameter of the roller set in mm,
D: rolling element 5 diameter in mm,
α: operating contact angle of the rolling element 5 in degrees, and
dₘ, D and a being geometrical features of the bearing 5.

In a variant, the rating life model (MODEL) may further take into account the misalignment value between the raceway of the stationary ring and the raceway of the rotatable rings from the load distribution.

In another embodiment, the rating life model (MODEL) may comprise the modified reference rating life model defined in ISO/TS 16281. In the modified reference rating life model, the misalignment is described by a lamina model.

The look-up table TAB2 determines the misalignment from the load distribution delivered by the load sensor 26. The look-up table TAB2 is for example set up from simulation.

The modified reference rating life model is such that:

$${L}_{nmr} = {a}_{1} {( {\sum }_{k = 1}^{{n}_{s}} \{ {a}_{ISO}^{- 9 / 8} [ {( \frac{{q}_{kci}}{{q}_{kei}} )}^{- 9 / 2} + {( \frac{{q}_{kce}}{{q}_{kee}} )}^{- 9 / 2} ] \} )}^{- 8 / 9}$$

where:
Lₙₘᵣ: the modified reference rating life value at n probability in millions of revolutions,
nₛ: is number of laminas,
k: is the k-lamina,
q_{kci}: is the basic dynamic load rating of the k-lamina of the first and second inner rings 12, 13,
A_{kce}: is the basic dynamic load rating of the k-lamina of the outer ring 9,
qₖₑᵢ: is the dynamic equivalent load on a k-lamina on the inner rings 12, 13, and
q_{kce}: is the dynamic equivalent load on a k-lamina on the outer ring 9.

q_{kci} and q_{kce} are determined from the number nₛ of laminas, the basic radial loading rating and features of the bearing 5.

qₖₑᵢ and q_{kce} are determined from the number of rolling elements, the load on each k-lamina and a stress function approximating the stress concentration at the inner ring raceway and the outer ring raceway.

In a variant, the modified reference rating life model defined in ISO/TS 16281 may be implemented without taking into account the misalignment between the raceway of the stationary ring and the raceway of the rotatable rings.

In another variant, the rating life model (MODEL) may for example comprise a stress-based Generalized Bearing Life Model (GBLM) or an Advanced Fatigue Calculation Model (AFC).

The sensorized rolling element 7, the rating life model (MODEL) of the bearing 5, the first determining means 34 and the second determining means 35 form a device for determining the USL value of the rolling bearing 5 in the machine 1. The device for determining the USL value of the rolling bearing 5 in the machine 1 may further comprise the third determining means 36, the storing means 37 and the comparing means 38.

When the machine 1 comprises the sensor 6, and the processing device 8 comprises the third determining means 36 and the table TAB, the third determining means 36 are intended to determine a machine value V1, Vn of a parameter representative of conditions of use of the machine 1 delivered by the sensor 5 associated with each measurement, and the storing means 37 are intended to store, for each measurement, the life rating value LR1, LRn determined by the rating life model (MODEL) and the associated machine value V1, Vn in the table TAB.

FIG. 5 illustrates schematically an example of a method for determining the USL of the bearing 5 in the machine 1. The method implements the device for determining the USL value of the rolling bearing 5 in the machine 1. During a step 40, the sensorized rolling element 7 determines a set of measurements. Each measurement comprises at least load values of the load distribution measured by the load sensor 26 of the sensorized rolling element 7. If the sensorized rolling element 7 comprises the speed sensor 27 and the temperature sensor 28, each measurement further comprises a rotational speed value of the sensorized rolling element 7 and a temperature value of the sensorized rolling element 7. A set of measurements may comprise for example between forty and two thousand measurements.

When the machine 1 comprises the sensor 6, the third determining means 36 determine the machine value V1, Vn of the parameter representative of the conditions of use of the machine associated with each measurement.

During a step 41, the first determining means 34 determine, for each measurement of the set of measurements, the life rating value LR1, LRn from the load values of the load distribution of the measurement and from the rating life model (MODEL) comprising the basic rating life model defined at equation.

If the sensorized rolling element 7 comprises the speed sensor 27 and the temperature sensor 28, the first determining means 34 determine, for each measurement of the set of measurements, the life rating value LR1, LRn from the load values of the load distribution of the measurement, the temperature value the measurement and the rotation speed of the measurement from the modified rating life model defined at equations, and the equation.

If the sensorized rolling element 7 comprises the speed sensor 27 and the temperature sensor 28, the first determining means 34 determine, for each measurement of the set of measurements, the life rating value LR1, LRn from the load values of the load distribution of the measurement, the temperature value the measurement and the rotation speed of the measurement, from the modified reference rating life model defined at equations, and the equation.

In variant, the first determining means 34 determine, for each measurement of the set of measurements, the life rating value LR1, LRn from the load values of the load distribution of the measurement, the temperature value the measurement, the rotation speed of the measurement and the misalignment, from the modified reference rating life model defined at equations, and the equation.

In variant, the rating life model (MODEL) may for example comprise a stress-based Generalized Bearing Life Model (GBLM) or an Advanced Fatigue Calculation Model (AFC).

Further, when the third determining means 36 determine the machine value V1, Vn of the parameter representative of the conditions of use of the machine associated with each measurement in step 40, the storing means 37 store for each measurement of the measurement set, the life rating value LR1, LRn of the measurement and the machine value V1, Vn associated to the measurement.

The storing means 37 may store the life rating value LR1, LRn of the measurement and the machine value V1, Vn associated with the measurement in the table TAB or a database.

During a step 42, when the life rating value LR1, LRn of each measurement of the set of measurements is determined by the first determining means 34 in step 41, the second determining means 35 determine the USL value of the bearing 5 from the life rating values determined by the first determining means 34.

The computation means 39 implement the Palmgren-Miner rule algorithm (ALGO) to determine the updated statistical life value Ln, n being an index referring to the failure probability, for example 1, 10, 50.

$$Ln = \frac{1}{{\sum }_{j = 1} \frac{{U}_{j}}{{LR}_{j}}}$$

where:
j: index for each load case, and
Uⱼ: duty cycle (percentage of occurrence of load case),
LRⱼ: life rating value determining from equation, or.

The duration between two consecutive measurements may be identical or different, and may be for example four hours.

In order two have an accurate USL value, when the storing means comprise the table (TAB) storing a plurality of machine values V1, Vn associated with life rating values LR1, LRn, the third determining means 36 determine at least an actual machine value from measurements delivered by the sensor 6 between two consecutive measurements of the set of measurements delivered by the sensorized rolling element 7. The comparing means 38 compare the actual machine value and the stored machine values in the table (TAB) to find a stored machine value equal to the actual machine value. The computation means 39 implement the Palmgren-Miner rule algorithm (ALGO) to determine the updated statistical life value Ln from the machine values and the stored machine values determined by the comparing means 38.

The updated statistical life is an indicator permitting a comparison of actual application conditions determined during operation to initially assumed or estimated application conditions and thus to identify critical application conditions, which might lead to damages or accelerated damage accumulation, in order to increase the operating time (life) of the bearing and reduce unplanned downtime of the machine.

The USL determined with the method for determining the USL may be determined continuously as measurements are performed continuously. The USL allows to determine the trend of the bearing life of the bearing 5. If the USL is deviating, counteractions on the application might be initiated to prolong the bearing life of the bearing 5.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved methods and devices for determining an updated statistical life of a bearing.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A method for determining an updated statistical life value of a rolling bearing in a machine, the rolling bearing comprising a stationary ring and a rotatable ring configured to rotate concentrically relative to one another and at least one row of rolling elements interposed between a first raceway on the stationary ring and a second raceway on the rotatable ring, at least one of the rolling elements being a sensorized rolling element comprising a load sensor configured to measure a load distribution across the sensorized rolling element, the method comprising:
determining a set of measurements, each measurement comprising at least load values of the load distribution measured by the load sensor of the sensorized rolling element,
for each measurement, determining a life rating value from at least the load values of the measurement and from a rating life model of the bearing, and
determining the updated statistical life value from at least the life rating values.

2. The method according to claim 1,
wherein the sensorized rolling element further comprises a temperature sensor configured to measure a temperature of the sensorized rolling element and to output a temperature measurement value and a speed sensor configured to measure a rotational speed of the sensorized rolling element and to output a rotational speed value, and
wherein the life rating value of each measurement is determined from the temperature measurement value, the rotational speed measurement value, geometrical features of the bearing, features of a lubricant of the bearing and the rating life model.

3. The method according to claim 2, further comprising:
determining a misalignment value between the first raceway and the second raceway from the load distribution, and
determining the life rating value of each measurement in part based on the misalignment value.

4. The method according to claim 1, further comprising:
determining a plurality of representative machine values of a parameter representative of use conditions of a machine in which the rolling bearing is installed, and
for each measurement, storing the life rating value and the associated machine value.

5. The method according to claim 5, further comprising:
determining an actual machine value of the parameter representative of the conditions of use of the machine, and
comparing the actual machine value and the plurality of representative machine values to find a representative machine value equal to the actual machine value,
wherein the updated statistical life value is determined from the life rating values and the life rating value associated with the representative machine value equal to the actual machine value.

6. The method according to claim 1,
wherein the machine is a wind turbine.

7. A device for determining an updated statistical life value of a rolling bearing in a machine, the rolling bearing comprising a stationary ring and a rotatable ring configured to rotate concentrically relative to one another and at least one row of rolling elements interposed between a first raceway on the stationary ring and a second raceway on the rotatable ring, a first one of the rolling elements comprising a sensorized rolling element, the device comprising:
a load sensor in the sensorized rolling element configured to measure a load distribution across the sensorized rolling element, the load distribution comprising load values,
a rating life model of the bearing,
first determining means configured to determine, for each measurement, a life rating value from at least the load values of the load distribution of the measurement and from the rating life model of the bearing, and
second determining means configured to determine the updated statistical life value from at least the life rating values.

8. The device according to claim 7, further comprising:
third determining means configured to determine a plurality of representative machine values of at least one parameter representative of conditions of use of a machine in which the rolling bearing is installed, and
storing means configured to store, for each measurement, the life rating value and the associated representative machine value.

9. The device according to claim 8,
wherein the third determining means are further configured to determine an actual machine value of the parameter representative of the conditions of use of the machine,
the device further comprising comparing means configured to compare the actual machine value and the representative machine values to find a representative machine value equal to the actual machine value, and
the second determining means being further configured to determine the updated statistical life value from the life rating values and the stored life rating value associated with the representative machine value equal to the actual machine value.

10. A wind turbine comprising:
a rolling bearing, the rolling bearing comprising a stationary ring and a rotatable ring configured to concentrically relative to one another, and at least one row of rolling elements interposed between a raceway of the stationary ring and a raceway of the rotatable ring, and
a device according to claim 7.
